(19) United States
(12) Patent Application Publication
(10) Pub. No.: US 2014/0214775 A1
(43) Pub. Date: Jul. 31, 2014

(54) SCALABLE DATA DEDUPLICATION

(71) Applicant: FUTUREWEI TECHNOLOGIES, INC., Plano, TX (US)

(72) Inventors: Guangyu Shi, Cupertino, CA (US); Jianming Wu, Fremont, CA (US); Gopinath Palani, Sunnyvale, CA (US)

(73) Assignee: FUTUREWEI TECHNOLOGIES, INC., Plano, TX (US)

(21) Appl. No.: 13/802,532

(22) Filed: Mar. 13, 2013

Related U.S. Application Data
(60) Provisional application No. 61/758,085, filed on Jan. 29, 2013.

(51) Int. Cl. G06F 17/30

(52) U.S. Cl. CPC G06F 17/30156
USPC 707/692

(57) ABSTRACT

A method implemented on a node, the method comprising receiving a key according to a sub-index of the key, wherein the sub-index identifies the node, and wherein the key corresponds to a data segment of a file, determining whether the data segment is stored in a data storage system according to whether the key appears in a hash table.

### CROSS-REFERENCE TO RELATED APPLICATIONS

The present application claims priority to U.S. Provisional Patent Application No. 61/758,085 filed Jan. 29, 2013 by Guangyu Shi, et al. and entitled “Method to Scale Out Data Deduplication Service”, which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Data deduplication is a technique for compressing data. In general, data deduplication works by identifying and removing duplicate data, such as files or portions of files, in a given volume of data in order to save storage space or transmission bandwidth. For example, an email service may include multiple occurrences of the same email attachment. For the purposes of illustration, suppose the email service included 50 instances of the same 10 megabyte (MB) attachment. Thus, 500 MB of storage space would be required to store all the instances if duplicates are not removed. If data deduplication is used, only 10 MB of space would be needed to save and store one instance of the attachment. The other instances may then refer to the single saved copy of the attachment.

Data deduplication typically comprises chunking and indexing. Chunking refers to contiguous data being divided into segments based on pre-defined rules. During indexing, each segment may be compared with historical data to see if the segment being examined is a duplicate or not. Duplicated segments may be filtered out and not stored or transmitted, allowing the total size of data to be greatly reduced.

It may be important to scale data deduplication to run on a cluster of servers because reliance on a single server to perform all or most of the tasks may lead to bottlenecks or vulnerability of the system to failure of a single server. The chunking stage may be scaled to run on multiple servers as the processing is mainly local. As long as each server employs the same algorithm and parameter set, the output should be the same whether it is processed by a single server or multiple servers. However, the indexing stage may not be easily scalable, since a global table may be conventionally required to determine whether a segment is duplicated or not. Thus, there is a need to scale out the data deduplication service to mitigate overreliance on a single server.

### SUMMARY

In one embodiment, the disclosure includes a method implemented on a node, the method comprising receiving a key according to a sub-index of the key, wherein the sub-index identifies the node, and wherein the key corresponds to a data segment of a file, determining whether the data segment is stored in a data storage system according to whether the key appears in a hash table.

In another embodiment, the disclosure includes a node comprising a receiver configured to a receive a key according to a sub-index of the key, wherein the sub-index identifies the node, and wherein the key corresponds to a data segment of a file, and a processor coupled to the receiver and configured to determine whether the data segment is stored according to whether the key appears in a hash table.

In yet another embodiment, the disclosure includes a node comprising a processor configured to acquire a request to store a data file, chunk the data file into a plurality of segments, determine a key value for a segment from the plurality of segments using a hash function, and identify a locator node (L-node) according to a sub-key index of the key value, wherein different sub-key indexes map to different L-nodes, and a transmitter coupled to the processor and configured to transmit the key value to the identified L-node.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic of an embodiment of a data storage system.

FIG. 2 is a schematic diagram of an embodiment of a file system tree.

FIG. 3 is a flowchart of an embodiment of a scalable data de-duplication method.

FIG. 4 illustrates an embodiment of a network component for implementation.

FIG. 5 is a schematic diagram of an embodiment of a general-purpose computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are systems, methods, and apparatuses for scaling a data deduplication service to operate among a cluster of servers. “Servers” may be referred to herein as “nodes” due to their interconnection in a network. There may be three types of nodes used to perform different tasks. A first type of node may perform chunking of the data into segments. A second type of node may include a portion of an index table in order to determine whether or not a segment is duplicated. A third type of node may store the deduplicated or filtered segments. The first type of node may be referred to as a portable operating system interface (POSIX file system) node or P-node, the second type of node may be referred to as a locator node or L-node, and the third type of node may be referred to as an objector node or O-node. There may be a plurality of a given type of node, which may be organized into a cluster of that type of node. The different types of nodes may collaboratively perform the data deduplication service in a distributed manner in order to reduce system bottlenecks and vulnerability to node failures.

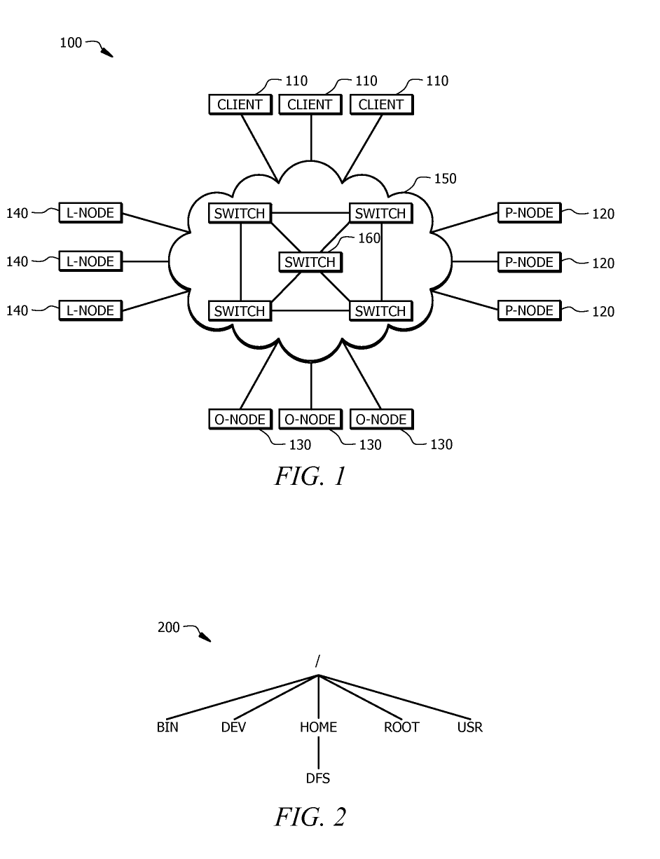

FIG. 1 illustrates a schematic of an embodiment of a data storage system 100 that employs data deduplication. The system 100 may comprise a plurality of clients 110, P-nodes 120, O-nodes 130, and L-nodes 140 connected via a network 150 as shown in FIG. 1. Although only three of each component (e.g., clients 110, P-nodes 120, O-nodes 130, and L-nodes 140) are shown for illustrative purposes, any number of each component may be used in a data deduplication system. The network 150 may comprise one or more switches 160 which may use software defined networking or Ethernet technology. A client 110 may be an application on a device that has remote data storage needs. The device may be, e.g., a desktop computer, a tablet, or a smart phone. In system 100, a client 110 may make a request to store a file, in which case the file is transferred to a P-node 120. A P-node may be selected based on the target data directory of the file. The P-node 120 may be the node that handles data chunking into multiple segments based on predefined rules, which may be file-based (each file is a chunk), block-based (each fixed length block is a chunk) or byte-based (variable length bytes data is a chunk). The P-node 120 may generate fingerprints for the segments via a hash function. The fingerprint of a segment may be a digest of the piece of data, represented as a string of binaries. For example, Security Hash Algorithm 1 (SHA1) or Message Digest 5 (MH5) may be used to derive segment fingerprints when they are applied to the data segments.

FIG. 2 depicts an embodiment of hosting directories in a file system tree 200. The file system 200 may comprise one or more directories and subdirectories which may be hosted by a P-node, such as P-node 120. P-nodes may be organized based on a file tree structure, since this is the conventional structure for most file systems. P-nodes may collectively cover the whole file system tree, as seen in FIG. 2's system tree 200 which is covered by a cluster of three P-nodes with hosting directories shown in Table 1 (the /bin, /dev, and /usr directories may contain system files).

TABLE 1
An example of host mapping of P-nodes.

| Server_ID | Hosting Directories |
|---|---|
| P_A | / |
| P_B | /home |
| P_C | /root, /home/dfs |

Once the segments and the corresponding fingerprints have been generated at the selected P-node 120, the L-nodes 140 may be engaged. The L-nodes 140 may be indexing nodes which determine whether a segment is duplicated or not. The proposed data deduplication may utilize a distributed approach in which each L-node 140 is responsible for a particular key set. The system 100 may therefore not be limited by the sharing of a centralized global table, but the service may be fully distributed among different nodes.

The L-nodes 140 in the storage system 100 may be organized as a Distributed Hash Table (DHT) ring with segment fingerprints as its keys. The key space may be large enough that it may be practical to assume a one-to-one mapping between a segment and its fingerprint without any collisions. A cluster of L-nodes 140 may be used to handle all or a portion of the key space (as the whole key space may be too large for any single L-node). Conventional allocation methods may be applied to improve the balance of load among these L-nodes 140. For example, the key space may be divided into smaller non-overlapping sub-key spaces, and each L-node 140 may be responsible for one or more non-overlapping sub-key spaces. Since each L-node 140 manages one or more non overlapping portions of the whole key space, there may be no need to communicate among L-nodes 140.

Table 2 shows an example of a key space being divided evenly into 4 sub-key spaces. The example given assumes four L-nodes, wherein each node handles a non-overlapping sub-key space. The prefix in Table 2 may refer to first two bits of a segment fingerprint or key. Each P-node may store this table and use it to determine which L-node is responsible for a segment. The segment may be sent to the appropriate L-node depending on the specific sub-key space prefix.

TABLE 2
An example of L-nodes with associated sub-key space.

| Server_ID | Sub-Key Space Prefix |
|---|---|
| L_A | 00 |
| L_B | 01 |
| L_C | 10 |
| L_D | 11 |

Returning to the embodiment of FIG. 1, if a segment is new, its storage space may be allocated by the L-node 140; otherwise, a locator of the segment may be returned, containing, for example, the segment's pointer, its size, and possibly other associated information.

After filtering and indexing, unique segments may be stored in the cluster of O-nodes 130. The O-nodes 130 may be storage nodes that store new segments based on their locators. The O-nodes 130 may be loosely organized if the space allocation functionality is implemented in the L-nodes. In one embodiment, each L-node 140 may allocate a portion of the space on a certain O-node 130 when a new segment is encountered (any of a number of algorithms, such as a round robin algorithm, may be used for allocating space on the O-nodes). Alternatively, in another embodiment, the O-nodes 130 may be strictly organized. For example, the O-nodes 130 may form a DHT ring with each O-node 130 responsible for the storage of segments in some sub-key spaces, similar to how L-nodes 140 are organized. As a person of ordinary skill in the art will readily recognize, other organization forms of O-nodes 130 may be applied, as long as there is defined mapping between each segment and its storage node.

By way of further example, suppose a client 110 wanted to write a file into the storage system. The file may first be directed to one of the P-nodes 120, based on the directory of each file. Each switch 160 may store or have access to a file system map (e.g., a table such as Table 1) which determines which P-node 120 to communicate with depending on the hosting directory. The selected P-node 120 may then chunk the data into segments and generate corresponding fingerprints. Next, for each segment, an L-node 140 may be selected to check whether or not a particular segment is duplicated. If the segment is new, an O-node 130 may store the data. The data would not be stored if it was already in the storage system.

In an example of a data read from a system, a client 110 request may first go to a certain P-node 120 where pointers to the requested data reside. The P-node 120 may then search a local table which contains all the segments information needed to reconstruct that data. Next, the P-node 120 may send out one or more requests to the O-nodes 130 to retrieve each segment. Once all of the segments have been collected, the P-node 120 may put them together and return the data to the client 110. The P-node 120 may also return the data to the client 110 portion by portion based on the availability of segments.

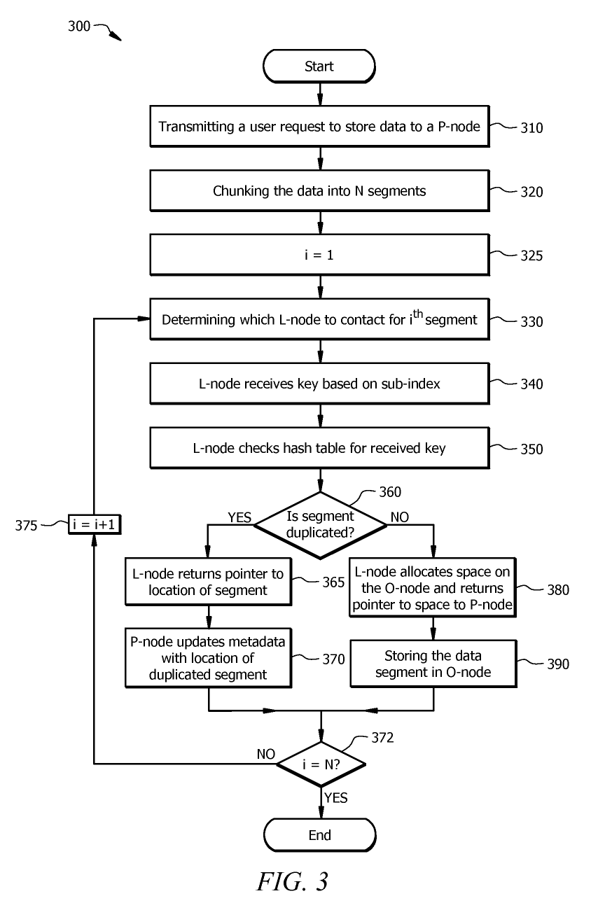

FIG. 3 is a flowchart 300 of an embodiment of a method of storing data. The steps of the flowchart 300 may be implemented in a data storage system with at least one P-node, at least one O-node, and a plurality of L-nodes, such as data storage system 100 comprising P-nodes 120, O-nodes 130, and L-nodes 140. The flowchart begins in block 310, in which a P-node (e.g., the P-node 120 in FIG. 1) may receive data from a client request. The specific P-node may be selected according to the target host directory of the file (e.g., using a table such as Table 1). Next in block 320, chunking may occur in which the P-node parses or divides the data into N segments based on predefined rules, where N is an integer that satisfies N≧1. Further, a hash function may be applied to each segment to generate a fingerprint or key for each segment. At block 325, an iterative step may be introduced, in which i refers to the index for the i^{th} segment. The method continues in block 330, where the P-node may determine which L-node (such as an L-node 140) to contact for the i^{th} segment. The L-node may be selected based on a sub-key of the i^{th} segment's fingerprint. The key space may be partitioned among the various L-nodes. At block 340, the key may be transmitted to the selected L-node and the L-node receives the key.

At block 350, the L-node may check whether or not the segment is stored in an O-node (e.g., an O-node 130 in FIG. 1) according to whether the key appears in a hash table stored in the L-node. The hash table may use keys to lookup storage locations for corresponding data segments. Each L-node may have its own subset of keys for assignment of spaces on the O-node. Based on this information, at block 360 the L-node may determine whether or not the segment is duplicated. If the segment is already stored, then the L-node may return or transmit an indication of location information of the segment (e.g., a pointer to the location as well as the size of the allocated space) to the P-node in block 365, and the P-node may update the corresponding metadata with the location of the duplicated segment in block 370. As a result, the i^{th} segment may not be stored because it is a duplicate. Otherwise, if not a duplicate, the method continues in block 380, where the L-node may allocate space on the O-node and the L-node may return location information (e.g., a pointer to the allocated space) to the P-node that made the request. At block 390, the original data segment may be stored on the O-node. After block 360, the L-node may return an indication of whether the segment is duplicated to the P-node. The indication may be explicit or implicit. The indication may be one bit sequence if the segment is duplicated and a different bit sequence if the segment is not duplicated. After blocks 370 or 390 as the case may be, a determination is made whether i=N in decision block 372 (i.e., whether all N segments have been tested for duplication). If so, the flowchart may end. If not, the value of i is incremented by one in block 375 and the flowchart 300 returns to block 330.

In the embodiment 300, a P-node may only send a key value to an L-node without transmitting the corresponding segment to the L-node. If the segment needs to be stored after checking for duplicates, the P-node may send the segment to the selected O-node. In an alternative embodiment, a segment may be transmitted from the P-node to the L-node. If it is determined by the L-node that the segment is not a duplicate, the L-node can send the segment to the selected O-node.

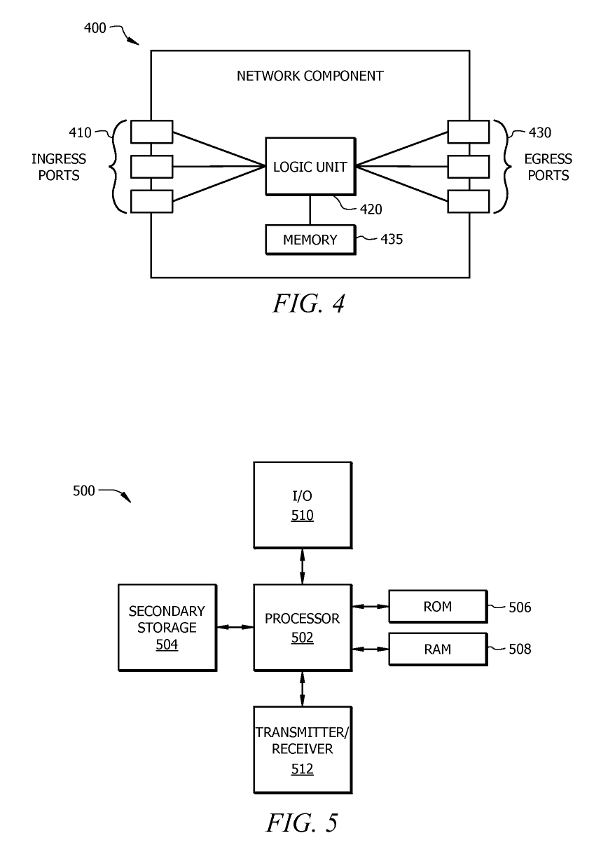

At least some of the features or methods described in the disclosure may be implemented on any general-purpose network component, such as a computer system or network component with sufficient processing power, memory resources, and network throughput capability to handle the necessary workload placed upon it. FIG. 4 shows an example of a network component 400 which may be used for implementation of switches used in a storage system 100 such as switch 160. The network component 400 may comprise a plurality of ingress ports 410, a processor or logic unit 420, a memory device 435, and a plurality of egress ports 430. The ingress ports 410 and egress ports 430 may be used for receiving and transmitting data, segments, or files from and to other nodes, respectively. The logic unit 420 may be utilized for determining which nodes to send the frames to and may comprise one or more multi-core processors. The ingress ports 410 and/or egress ports 430 may also contain electrical and/or optical transmitting and/or receiving components. The memory device 435 may store information for mapping files to P-nodes, an example of which is shown in Table 1.

FIG. 5 illustrates a computer system 500 suitable for implementing one or more embodiments of the components disclosed herein, such as the P-nodes 120, O-nodes 130, and L-nodes 140. The computer system 500 includes a processor 502 (which may be referred to as a CPU) that is in communication with memory devices including secondary storage 504, read only memory (ROM) 506, random access memory (RAM) 508, input/output (I/O) devices 510, and transmitter/receiver (or transceiver) 512. The processor 502 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. Processor 502 may implement or be configured to perform any of the functionalities of clients, P-nodes, O-nodes, or L-nodes, such as portions of the flowchart 300.

The secondary storage 504 is typically comprised of one or more disk drives or tape drives and is used for non-volatile storage of data and as an overflow data storage device if RAM 508 is not large enough to hold all working data. Secondary storage 504 may be used to store programs that are loaded into RAM 508 when such programs are selected for execution. The ROM 506 is used to store instructions and perhaps data that are read during program execution. ROM 506 is a non-volatile memory device that typically has a small memory capacity relative to the larger memory capacity of secondary storage 504. The RAM 508 is used to store volatile data and perhaps store instructions. Access to both ROM 506 and RAM 508 is typically faster than to secondary storage 504.

I/O devices 510 may include a video monitor, liquid crystal display (LCD), touch screen display, or other type of video display for displaying information. I/O devices 510 may also include one or more keyboards, mice, or track balls, or other well-known input devices.

The transmitter/receiver 512 may serve as an output and/or input device of computer system 500. The transmitter/receiver 512 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. The transmitter/receiver 512 may enable the processor 502 to communicate with an Internet and/or one or more intranets and/or one or more client devices.

It is understood that by programming and/or loading executable instructions onto the computer system 500, at least one of the processor 502, the ROM 506, and the RAM 508 are changed, transforming the computer system 500 in part into a particular machine or apparatus, such as an L-node, P-node, or O-node, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method implemented on a node, the method comprising:
receiving a key according to a sub-index of the key, wherein the sub-index identifies the node, and wherein the key corresponds to a data segment of a file; and
determining whether the data segment is stored in a data storage system according to whether the key appears in a hash table.

2. The method of claim 1, wherein the data segment is determined as stored if the key appears in the hash table, and wherein the data segment is determined as not stored if the key does not appear in the hash table.

3. The method of claim 1, wherein the key space spans a plurality of nodes that includes the node, and wherein the key space is divided into non-overlapping regions and each of the plurality of nodes is responsible for one of the non-overlapping regions.

4. The method of claim 1, further comprising transmitting an indication whether the data segment is stored.

5. The method of claim 2, further comprising:
if the data segment is determined as not stored:
allocating storage on an objector node (O-node) for the segment; and
generating a first pointer to the allocated storage.

6. The method of claim 5, further comprising:
if the data segment is determined as stored:
generating a second pointer to a location of the data segment on an O-node.

7. The method of claim 4, wherein the key is received from a portable operating system interface (POSIX) node (P-node), and wherein the indication is transmitted to the P-node.

8. A node comprising:
a receiver configured to a receive a key according to a sub-index of the key, wherein the sub-index identifies the node, and wherein the key corresponds to a data segment of a file; and
a processor coupled to the receiver and configured to determine whether the data segment is stored according to whether the key appears in a hash table.

9. The node of claim 8, wherein the data segment is determined as stored if the key appears in the hash table, and wherein the data segment is determined as not stored if the key does not appear in the hash table.

10. The node of claim 8, wherein the key space spans a plurality of nodes that includes the node, and wherein the key space is divided into non-overlapping regions and each of the plurality of nodes is responsible for one of the non-overlapping regions.

11. The node of claim 8, further comprising a transmitter configured to transmit an indication whether the data segment is stored.

12. The node of claim 9, wherein the processor is further configured to:
if the data segment is determined as not stored:
allocate storage on an objector node (O-node) for the segment; and
generate a first pointer to the allocated storage.

13. The node of claim 12, wherein the processor is further configured to:
if the data segment is determined as stored:
generate a second pointer to a location of the data segment on an O-node.

14. The node of claim 11, wherein the key is received from a portable operating system interface (POSIX) node (P-node), and wherein the indication is transmitted to the P-node.

15. The node of claim 10, wherein the plurality of nodes is a cluster of locator nodes (L-nodes.

16. A node comprising:
a processor configured to:
acquire a request to store a data file;
chunk the data file into a plurality of segments;
determine a key value for a segment from the plurality of segments using a hash function; and
identify a locator node (L-node) according to a sub-key index of the key value, wherein different sub-key indexes map to different L-nodes; and
a transmitter coupled to the processor and configured to:
transmit the key value to the identified L-node.

17. The node of claim 16, further comprising:
a receiver coupled to the processor and configured to receive the request, wherein the request was transmitted to the node based on the node being responsible for a directory in which the data file is to be stored.

18. The node of claim 16, further comprising:
a receiver configured to:
receive an indication from the identified L-node whether the segment is stored, wherein if the segment is indicated as not stored, the indication includes a pointer to allocated space on an objector node (O-node) and the processor is further configured to direct the segment to the allocated space on the O-node for storage.

19. The node of claim 18, wherein if the segment is indicated as stored, the indication indicates the O-node where the segment is stored, and the processor is further configured to request the segment from the O-node where the segment is stored.

20. The node of claim 16, wherein the key space of the hash function is partitioned over the different L-nodes.
